(19) United States
(12) Patent Application Publication
(10) Pub. No.: US 2005/0087374 A1
(43) Pub. Date: Apr. 28, 2005

(54) Chain drive assembly for a tracked vehicle

(76) Inventors: Helmut Kanzler, Voehringen (DE); Michael Kuhn, Laupheim (DE); Bernd Junginger, Blaustein (DE)

Correspondence Address: GREENBERG TRAURIG, P.C.;Suite 2500, 77 West Wacker Drive, Chicago, IL, 60601, US

(21) Appl. No.: 10/310,706

(22) Filed: Dec. 5, 2002

(30) Foreign Application Priority Data
Dec. 7, 2001 (DE) 10160918.3-21

(51) Int. Cl. B62D 55/00

(52) U.S. Cl. 180/9.5

(57) ABSTRACT

A chain drive assembly for a tracked vehicle with two drive sides, each of which has a traveling chain guided over several wheels, is provided, with at least two adjacent wheels (5-7) which are rotatably supported on swinging projections (11, 12, 19), the two swinging projections (11, 12, 19) being supported on the vehicle side with the freedom to pivot around a common pivot axis (10, 10a), which is parallel to the rotational axes of the wheels (5-7).

### BACKGROUND OF THE INVENTION

1. The Technical Field

The invention pertains to a chain drive assembly for a tracked vehicle with a drive on each side, each of which has a traveling chain which is guided over several wheels.

2. The Prior Art

A chain drive assembly for a tracked vehicle in the form of a ski slope grooming vehicle is generally known. The chain drive assembly is part of an undercarriage, which has a drive on each of the two opposite sides of the vehicle. The drive on each side has a tumbler to serve as the drive wheel, which is driven preferably by a hydraulic drive system. The chain also passes over several running wheels, which have the function of guiding the chain. At least one wheel is designed as a tensioning wheel, the position of which relative to the chain can be adjusted to change the tension of the chain.

### SUMMARY OF THE INVENTION

The task of the invention is to create a chain drive assembly of the type indicated above which makes it possible to obtain a tracked vehicle with improved driving comfort.

This task is accomplished in that at least two adjacent wheels are rotatably supported on swinging projections, and that the two swinging projections are supported on the vehicle with freedom to pivot around a common pivot axis, which is parallel to the rotational axes of the wheels. Because of the increased mobility of at least one pair of wheels, it is possible to improve the driving comfort. In particular, the suspension of the vehicle is improved.

As an elaboration of the invention, the two swinging projections are supported with the freedom to change their angle with respect to each other. The swinging projections can therefore spread apart from each other or come closer together.

In a further elaboration of the invention, elastic restoring apparatus are provided for at least one of the swinging projections to exert a restoring moment, which acts to restore the static resting state after at least one of the swinging projections has been dynamically deflected. As a result, two different functions can be performed by the same simple construction. First, as a result of the pivoting support of the swinging projections, it becomes possible for the undercarriage and thus for the tracked vehicle to rock up and down. Second, the elastic restoring apparatus act as springs.

In a further elaboration of the invention, the pivoting support of the swinging projections has an outer polygonal profile assigned to the one swinging projection and a polygonal profile integrated into the outer, hollow profile, the inner profile being assigned to the other swinging projection. The inner profile has an outer cross section which is smaller than the inside cross section of the outer hollow profile to such an extent that a free space remains between the outer hollow profile and the inner polygonal profile, this space being at least mostly filled by at least one elastomeric body. When the inner polygonal profile rotates relative to the surrounding, outer hollow profile, therefore, the elastomeric body is necessarily compressed and thus produces a restoring moment acting in the direction of the no-load resting state. The inner polygonal profile as well as the outer, hollow profile are preferably triangular or square. The farther the polygonal form in question departs from a circle, the greater will be the restoring moment of the minimum of one elastomeric body. As a result of this design, an especially advantageous spring suspension is achieved, because the elastomeric body as well as the inner polygonal profile are integrated into the outer hollow profile and are completely protected by it. As a result of the integrated arrangement, furthermore, the amount of space which is occupied is very small. It is advantageous to provide several elastomeric bodies, one in each of the corner areas of the ring-shaped free space. The provision of several elastomeric bodies, which are produced independently of each other, simplifies the installation of the overall arrangement. In addition, it is very easy to replace one or more of the elastomeric bodies after they have become worn out. it is especially advantageous to provide a four-sided profile with a square cross section as the inner polygonal profile and another four-sided profile, also with the square cross section, as the outer hollow profile, where the corners of the inner hollow profile are turned 45° around the pivot axis with respect to the other hollow profile. It is thus possible to insert four elastomeric bodies in the resulting corner areas of the free space. The elastomeric bodies are preferably cylindrical in the no-load state. The elastomeric bodies are preferably pressed into position, so that, even in the no-load, resting state, a clamping effect is obtained, which creates a certain amount of pretension and guarantees that the inner polygonal profile is held without play in the outer, hollow profile. After they have been pressed into position, the cross section of the elastomeric bodies is approximately triangular.

In a further elaboration of the invention, the chain drive assembly is designed as a trapezoidal chain gear, in which one of the wheels is designed as a running wheel and another as a tensioning wheel. Tensioning apparatus are provided, which connect the swinging projections to a common tensioning pendulum, at least during the operation of the trapezoidal chain gear. The tensioning apparatus establish a rigid connection between the swinging projections. The swinging projections are therefore unable to execute angular movements with respect to each other. As a result, the driving comfort of the tracked vehicle is considerably improved. The force ratio between the tensioning wheel and the running wheel can be freely selected through the choice of the geometry of the connecting linkage, that is, through the design of the swinging projections. As a result of the design according to the invention, it is possible to omit a dynamic chain-tensioning device. Because of the tensioning pendulum thus created, which is preferably located in the forward and upward-slanting part of the chain strand, the tension of the chain can be kept uniform even during rocking or deflecting movements of the wheels. Second, the degree to which the tracked vehicle noses down during braking is considerably reduced. The special feature of a trapezoidal chain gear is that, in the drive on each side of the vehicle, the part of the chain which is at front in the normal travel direction rises forward and upward at a slant. The same is also usually true for the part of the chain at the rear of the drive on both sides, so that, overall, each chain appears to form a trapezoid when viewed from the side. The use of a trapezoidal chain gear gives the tracked vehicle excellent climbing abilities. Even relatively large obstacles can be surmounted—obstacles which would stop conventional tracked vehicles with a rectangular geometry of the chain gear. The essential feature of the trapezoidal chain gear is that the wheels on the forward-most axle of the chain gear are shifted upward on both sides. In the present exemplary embodiment, these are the tensioning wheels of the tensioning pendulum. It is advantageous that an inward or outward deflection of the forward-most running wheel, that is, of the tensioning wheel, immediately brings about a compensating movement without any time delay. As a result of the floating support of the running wheels, the loads on the wheels are distributed equally, which is also advantageous. The floating movements and the deflections, that is, the inward or outward rocking movements, are superimposed on each other.

In a further elaboration of the invention, the tensioning apparatus have adjusting apparatus, which make it possible to change the distance between the rotational axis of the tensioning wheel and that of the adjacent running wheel. The adjusting apparatus allows the chain tension to be adjusted. This is done preferably before the tracked vehicle is put into operation. A threaded spindle, a hydraulic unit, a pneumatic unit, or an actuator of some other design can be used as the adjusting apparatus. It is also possible to perform adjustments during the operation of the vehicle by operating the selected actuator in a suitable manner.

### BRIEF DESCRIPTION OF THE DRAWINGS

Additional advantages and features of the invention can be derived from the following description of a preferred exemplary embodiment of the invention, which is illustrated in the following figures:

FIG. 1 shows a tracked vehicle with an embodiment of a chain gear according to the invention;

FIGS. 2-4 show schematic diagrams of the chain gear according to FIG. 1 in different operating situations;

FIG. 5 shows an enlarged view of a part of the chain gear according to FIGS. 1-4 in the area of the forward running wheel axis;

FIG. 6 shows in schematic fashion another view of the tensioning pendulum according to FIG. 5;

FIG. 7 shows a pair of running wheels of the chain gear according to FIGS. 1-4 designed in the form of a running pendulum; and

FIG. 8 shows a cross-sectional view of the running pendulum according to FIG. 7.

### DETAILED DESCRIPTION OF THE INVENTION

A tracked vehicle 1 according to FIG. 1 has a chain drive assembly in the form of a trapezoidal chain gear 2. The trapezoidal chain gear 2 on each side of the undercarriage is provided with a chain 3, which passes over several wheels 4-7. The two sides of the undercarriage are of identical design. Each chain 3 is driven by a tumbler 4. This tumbler 4 is connected on each side of the vehicle to a hydraulic drive system, which will not be described in detail here. The two drive wheels 4 on the two sides of the vehicle are on the axis which is the farthest toward the rear in the direction of travel. Six additional wheel axes are assigned to each of the two chains 3 on the sides of the vehicle. For each chain 3, the wheel axis which is the farthest toward the front in the travel direction has a wheel 6, which is shifted forward and upward relative to the ground in comparison to the axes of the wheels 5 and 7. As a result, each chain 3 travels around an approximately trapezoidal path.

In the case of the trapezoidal chain gear 2 according to FIGS. 1-6, the other wheels 5-7 are arranged in pairs on each side, next to the solitary tumbler 4 at the rear, as will be described in greater detail below.

The wheels 6, 7 on the two forward wheel axes form together a tensioning pendulum in a manner to be described in greater detail below. The four running wheels 5, which guide the chain back to the tumbler 4 in the area where the chain 3 rises, are attached in pairs to form two running pendulums.

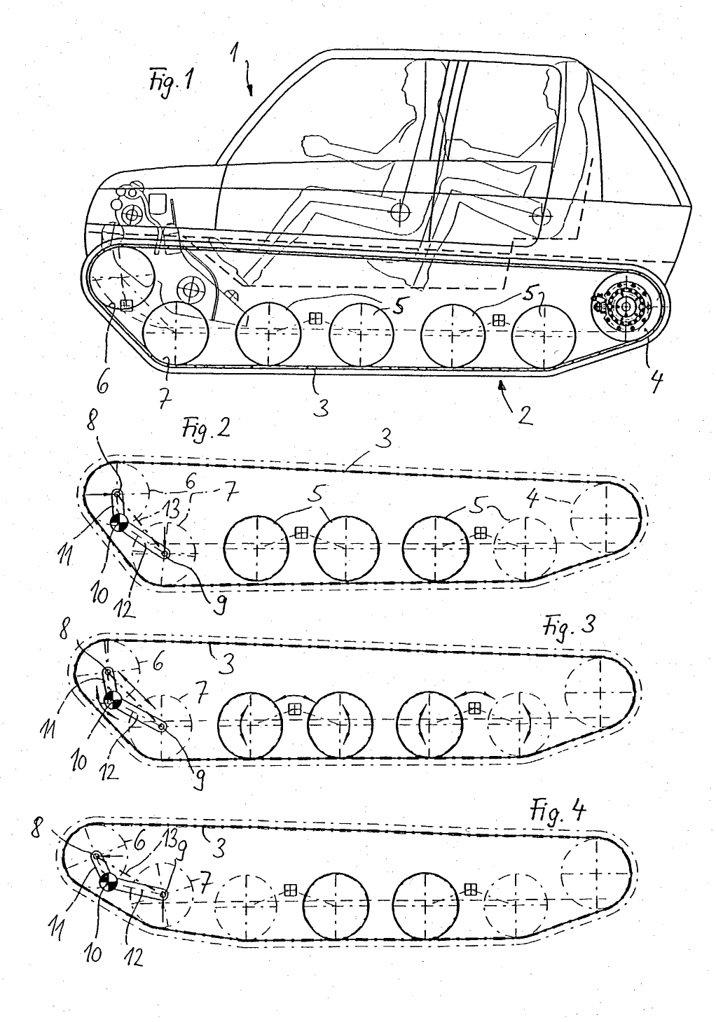

The design and function of the tensioning pendulum are described in greater detail below on the basis of FIGS. 2-6. The design and function of the running pendulum are then described on the basis of FIGS. 7 and 8.

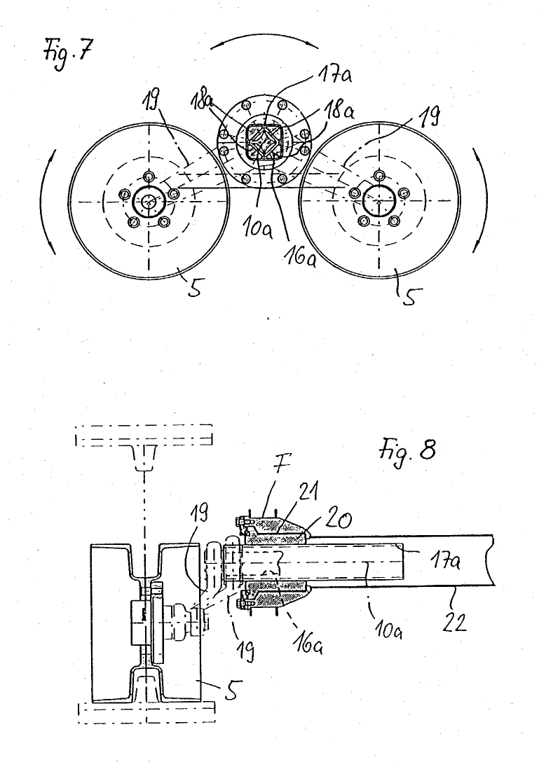

The wheels 6 and 7 on the wheel axis at the very front and on the one just behind are each supported on a swinging projection 11, 12 and are free to rotate around a rotational axis 8, 9. Each swinging projection 11, 12 is designed as a connecting lever. The two swinging projections 11, 12 are supported with freedom to pivot around a common pivot axis 10 on the vehicle frame F (FIG. 6). The distance between the rotational axis 8 of the upper, forward wheel 6 and the pivot axis 10 is equal to approximately half the distance between the rotational axis 9 of the lower, rear wheel 7 from the pivot axis 10. Accordingly, the swinging projection 11 is approximately half as long as the swinging projection 12. The short swinging projection 11 pivots freely around the pivot axis 10 according to FIG. 6. The lower swinging projection 12 is permanently connected, preferably by welding, to an inner polygonal profile 16 of a pivot bearing for the two swinging projections 11, 12. The inner polygonal profile, in the present case in the form of a square, is integrated into a hollow polygonal profile, in the present case a hollow square. The inner polygonal profile 16 is held in the outer hollow profile 17 with the help of elastomeric bodies 18, which have an approximately triangular cross section after they have been pressed into place, in such a way that the inner profile is rotated 45° with respect to the hollow profile 17. The outer hollow profile 17 is positively secured to the frame by way of a retaining flange 14, which, in the present case, is permanently connected to the vehicle frame F by screws.

The four elastomeric bodies 18 serve as restoring apparatus for the swinging projection 12. That is, they hold the swinging projection in a no-load, static resting position, and, whenever the swinging projection 12 rotates around the pivot axis 10, they exert a restoring moment on it to return it to the static resting position.

The two wheels 6, 7 act as a common tensioning pendulum. For this purpose, a rigid connection is provided between the swinging projections 11, 12, this connection being formed by a tensioning apparatus in the form of a linear actuator 13. The linear actuator 13 is hinged at one end to the lower swinging projection 12 and at the other end to a flange on the upper swinging projection 11. The linear actuator 13 in the present case is designed as a threaded spindle. By appropriate adjustment of the linear actuator 13, the distance between the rotational axes 8 and 9 of the two wheels 6, 7 from each other can be changed. Because the hinge points of the linear actuator 13 on the two swinging projections 11, 12 form a triangle with the pivot axis, a change in the length of the linear actuator 13 necessarily leads to a change in the angle between the shanks of the triangle, that is, between the swinging projections 11, 12.

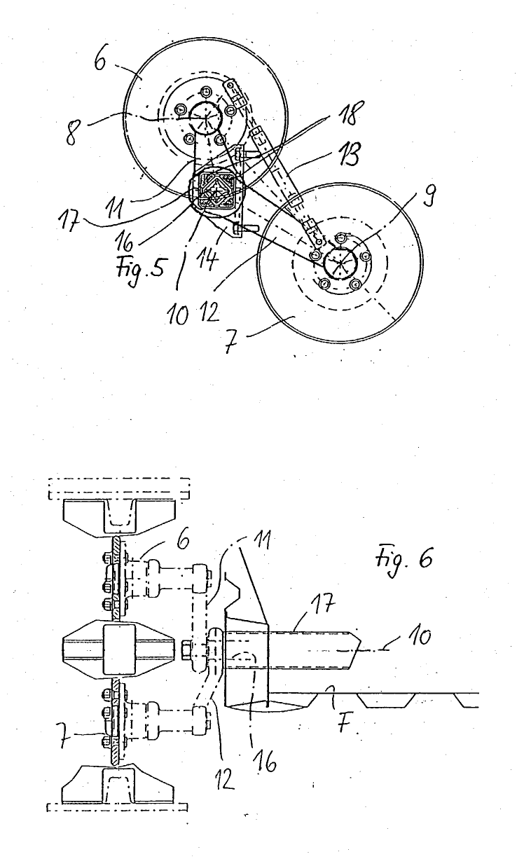

The lower wheel 7 serves as a running wheel. The upper wheel 6 serves as a tensioning wheel. The tension of the chain 3 can be adjusted by changing the angle between the two swinging projections 11, 12. As soon as the operating tracked vehicle 1 starts to move toward the left in the plane of the drawing, the running wheel 7 of the tensioning pendulum will be deflected inward or outward, depending on the ground over which the vehicle is traveling and the acceleration or deceleration of the tracked vehicle 1. FIG. 3 shows the static state of the chain drive, in which the tensioning pendulum is held in its no-load resting position by the elastomeric bodies 18. In FIG. 2, the forward running wheel 7 is deflected out and down. In FIG. 4, it is deflected in and up.

The tensioning wheel 6 tensions the chain 3 upon appropriate rotation of the linear actuator 13, which serves as a kinematic tensioning mechanism. After the chain 3 has been tensioned, the swinging projections 11, 12 form a rigid unit with the linear actuator 13, with the result that the common tensioning pendulum is formed.

An overload safety device is provided (not shown), which can be designed as a pressure-relief valve in the case of a hydraulic linear actuator 13 or as a spring-loaded safety device in the area of the pivot bearing. When the tensioning pendulum is deflected out of the static state, that is, in the case of an inward or outward deflection of the running wheel 7, the polygonal profile 16 is turned inside the hollow profile 17, as a result of which the elastomeric bodies 18 are compressed in the circumferential direction. These thus produce a restoring moment in the opposite circumferential direction, so that, after the dynamic load has ceased to act, a restoration to the static state will occur.

According to FIGS. 1-4, 7, and 8, two running pendulums are formed out of the four middle running wheel axes by grouping the running wheels 5 into pairs. The two running pendulums of the drive on one side are designed in the same way, so that the following description applies to both pendulums, which are arranged one behind the other in the longitudinal direction of the vehicle. As in the case of the tensioning pendulum, the two running wheels 5 of the running pendulum are each supported rotatably on a swinging projection 19. The two swinging projections 19 are designed in the same way, so that the rotational axes of the two running wheels 5 are the same distance from a pivot axis 10a. In geometric terms, therefore, the rotational axes of the two running wheels 5 and that of the central pivot bearing 10a form an isosceles triangle, which can be seen in FIG. 7. On the vehicle side, the two swinging projections 19 are supported on the vehicle frame F with freedom to pivot around the pivot axis 10a. The two swinging projections 19 are connected to each other in the area of the pivot bearing by elastic restoring apparatus. The one swinging projection 19 is permanently connected to an inner polygonal profile 16a, whereas the other swinging projection 19 is permanently connected to an outer polygonal profile 17a. The two profiles 16a, 17a are designed in a way similar to that previously described for the tensioning pendulum. In the free space between the inner polygonal profile 16a and the outer hollow profile 17a, four elastomeric bodies 18a are positioned to serve as restoring apparatus, which correspond to the elastomeric bodies 18 of the tensioning pendulum according to FIGS. 5 and 6. The key feature which is different about the running pendulum is that the outer hollow profile 17a is supported in a bearing bush 20 and a plain bearing 21 in the vehicle frame F with freedom of rotation around the pivot axis. The inner end of the hollow profile 17a projects into the hollow profile of a transverse axle beam 22, which is part of the rigid frame of the vehicle.

As a result of this design, the two running wheels 5 are given a floating suspension, as a result of which the wheel loads are distributed equally between the running wheels 5 suspended in this way. As a result of the elastomeric bodies 18a, the two swinging projections 19 form a stable unit in the static state, so that the two running wheels 5 are free to move in a floating manner around the pivot axis 10a as a single common pendulum. Inward and outward deflections essentially in the vertical direction are also possible, as the two swinging projections 19 are deflected from their static state. The swinging projections 19 preferably spread out relative to each other under the appropriate load. The running pendulum can thus rock around the pivot axis 10a and also deflect inward or outward in the vertical direction.

The tracked vehicle according to the invention is especially suitable for highway licensing.

1. A chain drive assembly for a tracked vehicle with two drive sides, each of which has a traveling chain guided over several wheels, characterized in that at least two adjacent wheels (5-7) are rotatably supported on swinging projections (11, 12, 19), and in that the two swinging projections (11, 12, 19) are supported on the vehicle side with freedom to pivot around a common pivot axis (10, 10a), which is parallel to the rotational axes of the wheels (5-7).

2. The chain drive assembly according to claim 1, characterized in that the two swinging projections (19) are supported so that the angle between them can be changed.

3. The chain drive assembly according to claim 1, characterized in that the swinging projections (11, 12, 19) are provided with elastic restoring apparatus (18, 18a), which exert a restoring moment aimed at restoring the static resting state whenever the swinging projections (11, 12, 19) are subjected to dynamic deflections.

4. The chain drive assembly according to claim 2, characterized in that the pivoting support of the swinging projections (11, 12, 19) has an outer, hollow, polygonal profile (17, 17a) assigned to one swinging projection (11, 12, 19) and an inner polygonal profile (16, 16a) assigned to the other swinging projection (11, 12, 19) and integrated into the outer hollow profile (17, 17a), the external cross section of the inner profile being smaller than the internal cross section of the outer hollow profile (17, 17a) to such an extent that a free space remains between the outer hollow profile (17, 17a) and the inner polygonal profile (16, 16a), which free space is at least mostly filled by at least one elastomeric body (18, 18a).

5. The chain drive assembly according to claim 1, characterized in that the chain drive assembly is designed as a trapezoidal chain gear, in which one of the wheels is designed as a running wheel (7) and the other as a tensioning wheel (6), and in that tensioning apparatus (13) are provided to connect the swinging projections (11, 12) together to form a common tensioning pendulum at least during the operation of the trapezoidal chain gear.

6. The chain drive assembly according to claim 5, characterized in that the tensioning apparatus have adjusting apparatus, which can be used to change the distance between the rotational axis (8) of the tensioning wheel (6) and the rotational axis (9) of the adjacent running wheel (7).

7. The chain drive assembly according to claim 1, characterized in that the rotational axes (8, 9) of the wheels (6, 7) are separated from the common pivot axis (10) by the same or different distances.

8. A tracked vehicle, including a chain drive assembly on two sides, each of which has a traveling chain guided over several wheels, characterized in that at least two adjacent wheels (5-7) are rotatably supported on swinging projections (11, 12, 19), and in that the two swinging projections (11, 12, 19) are supported on the vehicle side with freedom to pivot around a common pivot axis (10, 10a), which is parallel to the rotational axes of the wheels (5-7).
